(19) United States
(12) Patent Application Publication
(10) Pub. No.: US 2006/0226281 A1
(43) Pub. Date: Oct. 12, 2006

(54) Ducted fan vertical take-off and landing vehicle

(76) Inventor: Joh-Paul Christopher Walton, Culver City, CA (US)

Correspondence Address: Jon-Paul Walton, 11937 Jefferson Blvd. #2, Culver City, CA, 90230, US

(21) Appl. No.: 11/274,790

(22) Filed: Nov. 15, 2005

Related U.S. Application Data
(60) Provisional application No. 60/628,822, filed on Nov. 17, 2004.

(51) Int. Cl. B64C 27/08

(52) U.S. Cl. 244/17.23

(57) ABSTRACT

A vertical take-off and landing vehicle comprised of a fuselage having a front, a rear, and two lateral sides and a set of four thrusters set to the front, the left, the right, and the rear of said fuselage. The thrusters are either independently powered thrusters or could utilize a single power source. The thrusters, which are ducted fan units capable of providing a vertically upward force to the aircraft, are provided with such redundancy that the aircraft can hover with up to two thrusters inoperative. The thrusters are comprised of a set of two counter rotating propellers both of which creates lift. The two counter rotating propellers cancel out the torque effect normally created by using only one propeller. The Ducted fan units being movable between a first position in which they provide vertical lift and a second position in which they provide horizontal thrust using a set of servos and gears.

### CROSS-REFERENCE TO RELATED APPLICATIONS:

This application claims the benefit of provisional patent application Ser. No. 60/628822, file. 2004 Nov. 17 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

This invention generally relates to a vertical take-off and landing (VTOL) vehicle comprising a fuselage having a front, rear, and two sides, and four externally mounted thrusters. The four thrusters, which are ducted fan units, are positioned around the outside of the fuselage and located to the front, right, left, and rear of the fuselage. The four ducted fan units are capable of providing a vertically upward force to the aircraft, and provide such redundancy that the aircraft can hover with up to two thrusters inoperative on each side of the fuselage. Each thruster, on each side of the fuselage, creates lift from the propellers as well as from the acceleration of air from inlet to outlet.

2. Prior Art

With present day VTOL aircraft and hovercrafts there is not a practical way to make a personal flying vehicle. The problem is that once in motion inertia takes over and it is difficult and too cumbersome to steer a flying vehicle without a large turning or maneuvering radius. This large turning radius is inherent to rudder controlled vehicles. It is also necessary to have forward motion in order to maneuver a rudder controlled air vehicle. This large turning radius coupled with the lack of ability to brake in midair will continue to be the reasons personal flying vehicles will never take the place of cars. This makes the personal flying vehicle a non-practical commodity in our society unless these problems are resolved.

### BACKGROUND OF INVENTION—OBJECTS AND ADVANTAGES

My invention overcomes the turning radius and stopping ability problems inherit in current flying vehicles by the layout of the ducted fan units and the benefit of the ducted fan units maneuvering abilities. The ducted fan unit layout in my invention allows for the most accurate braking, turning, and maneuvering ability possible. This is accomplished by positioning the ducted fan units as such to not interfere with each others air intake or exhaust and to optimize the maneuverability of the vehicle. The location of the turning/maneuvering ducts, located at the front and rear of the fuselage, allows for optimal steering of the vehicle and minimizes the amount of exhaust being blown on the fuselage. This design also eliminates the need for forward motion while maneuvering. Turning the front and rear thrusters in the same direction allow for a perpendicular movement of the vehicle. The thrust and braking ducted fan units are located to the left and to the right of the fuselage. The invention can actually reverse all thrust for braking purposes as well as backward movement. The thrust ducts can be turned in conjunction with the maneuvering ducts to spin the vehicle on its axis. My invention also allows for more than one power source to power each thruster. This redundancy in power sources allows for a more secured flight.

Some configurations of manned or unmanned flight vehicles are only using one propeller per duct. This causes a problem if one of the ducts where to fail. The torque of the other rotating propellers would cause the vehicle to spin out of control; this is commonly known as the “torque effect”. My invention overcomes this problem by having each ducted fan unit counter its own torque effect with two counter rotating propellers per ducted fan unit.

This invention is intended to be used as a manned or unmanned flight vehicle. It is designed for use by military, law enforcement, industrial, security, transportation, search and rescue as well as for entertainment and toys.

### SUMMARY

The invention, a Ducted Fan Vertical Take-off and Landing Vehicle which has four ducted fan units, each with dual counter rotating propellers and a hollow pivot shaft, positioned around a fuselage as such: one ducted fan unit in front of said fuselage with its hollow pivot shaft facing the fuselage, one ducted fan unit to the left of said fuselage with its hollow pivot shaft facing the fuselage, one ducted fan unit to the right of said fuselage with its hollow pivot shaft facing the fuselage, and one ducted fan unit to the rear of the fuselage with its hollow pivot shaft facing the fuselage. The vehicles power source is located in said fuselage allowing for more than one motor or engine to power each ducted fan unit. This designs allows for multiple power sources. The power is transferred from the power sources through the hollow pivot shafts to each ducted fan unit using four drive shafts. The drive shafts extend from the fuselage through the hollow pivot shafts to the ducted fan units' gear boxes. The ducted fan unit gear box transfers power from the drive shaft to both of the propeller shafts inside said ducted fan unit gear box and thus to the propellers. The ducted fan units on the front and rear of the fuselage can be turned in conjunction, both to the left or right on their axis, to create sideway movement or opposite ways to spin the vehicle on its axis. The ducted fan units on the left and right side of the fuselage can be turned on their axis to face forward or backwards to create forward or reverse movement of the vehicle, as well as turned opposite directions to spin the vehicle on its axis. The ducted fan units are turned via a servo motor, servo motor gear, and hollow pivot shaft gear to maneuver the vehicle.

Accordingly, several objects and advantages of the invention are: to provide more control of a vertical take-off and landing vehicle, to provide more reliability with the use of additional power sources, to provide a means for stopping in midair, and to provide a means for safer air travel. Further objects and advantages will become apparent from a consideration of the ensuing description and drawings.

### DRAWINGS—FIGURES

FIG. 1a A perspective view from the top, left, rear of my invention showing the ducted fan units in the proper positions surrounded by an outer frame that is attached to the fuselage and helps hold the ducted fan units in place.

FIG. 1b A perspective view from the left, front with a different fuselage than in FIG. 1a that allows for the frame to hold the ducted fan units in place at their pivot points same as in FIG. 1a but with an outer frame that is below the ducted fan units turning radius, rather than level with it as in FIG. 1a.

FIG. 1c A perspective view from the top, left, front of the vehicle showing all four ducted fan units in place around the fuselage along with the outer frame from FIG. 1b.

FIG. 1d A top view of a fuselage with the ducted fan units mounted directly onto fuselage.

FIG. 2a A top view of vehicle with Fuselage from FIGS. 1b and 1c with a view of all four ducted fan units in place and the frame that holds the ducted fan units in place.

FIG. 2b A top view of vehicle with fuselage from FIG. 1a with a view of all four ducted fan units in place and the surrounding frame holding the ducted fan units in place.

FIG. 3a A perspective view from top, left, rear of my invention of the drive shaft system with the propellers in place showing two propellers per duct.

FIG. 3b A top view of the drive shaft system with the propellers in place.

FIG. 3c Top view close up of the main gear box that connects all the drive shafts together to transmit power to all the ducted fan units.

FIG. 4a A top view of duct without the propellers or drive shaft with a hollow pivot shaft and a non-hollow pivot shaft.

FIG. 4b An exploded perspective view of duct illustrating the ducts' hollow pivot shaft.

FIG. 4c An exploded perspective view of duct showing the ducts gear box.

FIG. 4d An exploded perspective view of duct showing the duct's hollow pivot shaft.

FIG. 5a A perspective view of the propeller unit, drive shaft, and beveled gears located inside the ducted fan unit (not shown).

FIG. 5b A perspective view of the propeller unit, drive shaft, and beveled gears located inside the ducted fan unit (not shown).

FIG. 5c A cutaway view of half a ducted fan unit with a view of the drive shaft and bevel gears without the propeller unit.

FIG. 5d A cutaway view of half the ducted fan unit with the drive shaft, beveled gears, and propellers.

FIG. 6a A partial view from top, right, front of my invention with fuselage from FIG. 1a without the fan duct illustrating the pivot shaft ducted fan unit holder on the external frame.

FIG. 6b A partial view of the outer frame that sets below the fuselage as in FIG. 1b with a closer look at the pivot shaft ducted fan unit mounting.

FIG. 6c A partial perspective view from the rear left of my invention with fuselage from FIG. 1b without the ducted fan units, illustrating the outer pivot shaft ducted fan unit holders.

FIG. 7 A top view of my invention without fuselage, with turned ducted fan units, drive shaft system, hollow pivot shaft, maneuvering system, motors, and servos in place.

FIG. 8 A top view of my invention without the fuselage showing a multi power source system layout and a multi power source power transfer means to transfer power to the ducted fan units.

FIG. 9a A top view of the duct without the propellers or drive shaft with the hollow pivot shaft.

FIG. 9b An exploded perspective view of the duct illustrating the ducts' hollow pivot shaft.

FIG. 9c An exploded perspective view of the duct showing the ducted fan units gear box.

FIG. 9d An exploded perspective view of duct showing the duct's hollow pivot shaft.

### DRAWINGS—REFERENCE NUMERALS

13 outer frame
15 outer frame with lowered support arms
16 fuselage hollow shaft opening
17 fuselage
20 ducted fan gear box
21 hole in gear box for shaft
24 hollow pivot shaft turning gear
25 hollow pivot shaft
26 servo/steering device
28 gear/transmission
29 main drive shaft
30 pivot shaft/non-hollow pivot shaft
31 left drive shaft
31 rear drive shaft
31 right drive shaft
33 beveled gear
35 support arms
36 main gear box
41 supporting ring
45 motor
50 power source and transfer gear (for use in a multi power source system)
51 power transfer gear (for use in a multi power source system)
60 enlarged ball bearing mounting
14a pivot shaft mounting
14b pivot shaft mounting
17a fuselage
17b fuselage
32a clockwise rotating propeller
32b counter-clockwise rotating propeller
33a clockwise rotating propeller shaft
33b counter-clockwise rotating propeller shaft
42a front ducted fan unit
42b left ducted fan unit
42c right ducted fan unit
42d rear ducted fan unit

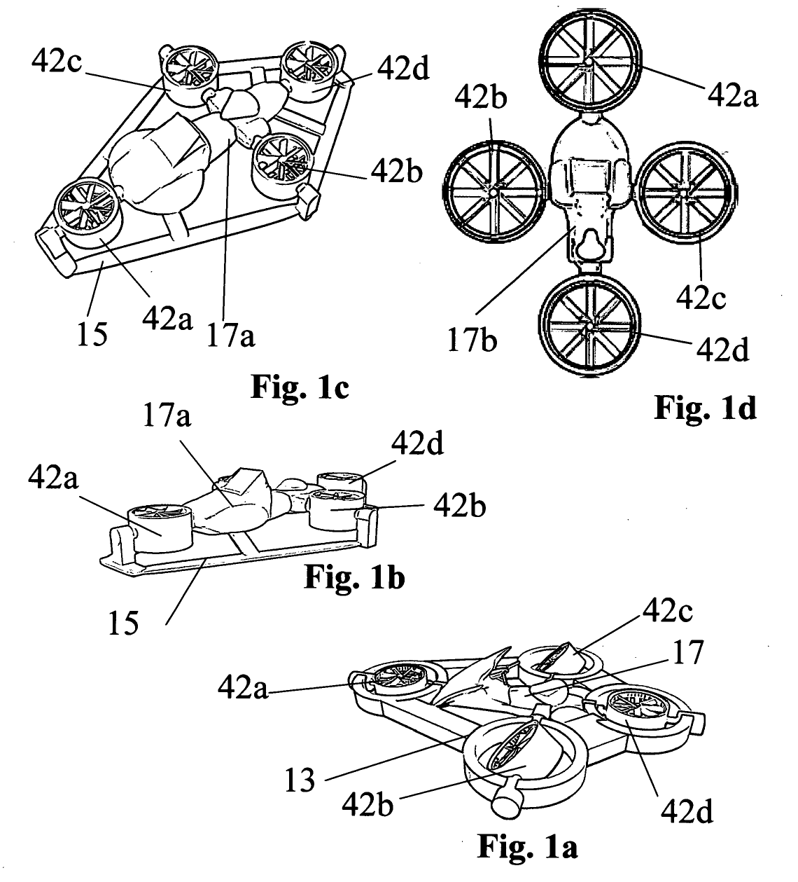

### DETAILED DESCRIPTION—FIGS. 1A, 1D, 2B, 4A, 4B, 4C, 4D, 5A, 5B, 5C, 5D, 6A, 6C, 8, 9A, 9B, 9C, 9D—PREFERRED EMBODIMENT

The preferred embodiments of the present invention will now be described with reference to FIGS. 1A, 1D, 2B, 4A, 4B, 4C, 4D, 5A, 5B, 5C, 5D, 6A, 6C, 8, 9A, 9B, 9C, and 9D of the drawings. Some identical elements in the various figures are identified with the same reference numerals. Some identical elements have been given different reference numerals to identify their position and to avoid confusion.

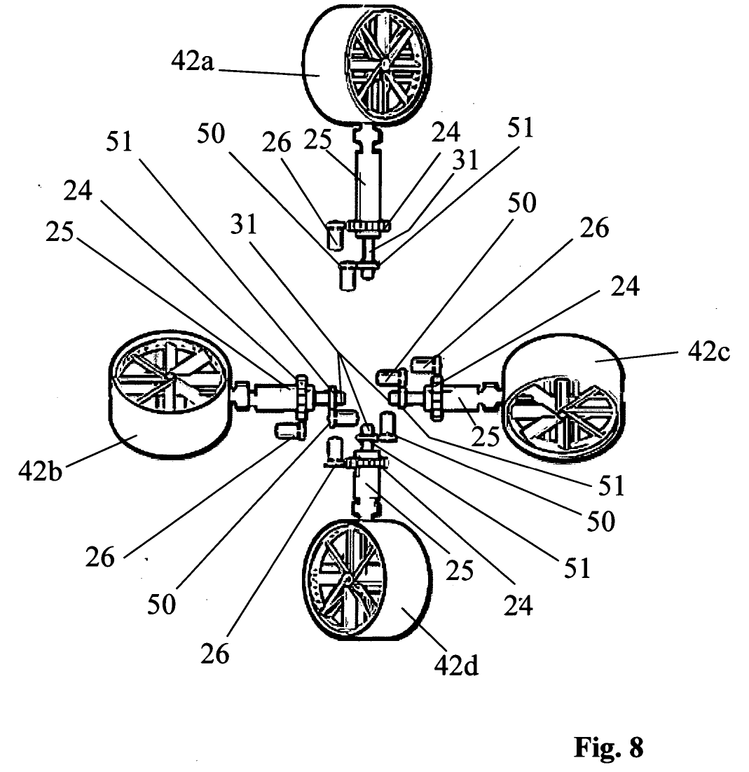

The first preferred embodiment is described in reference to FIGS. 1d, 5a, 5b, 5c, 6c, 8, 9a, 9b, 9c, and 9d of the invention, a vertical take-off and landing vehicle (VTOL). Shown in FIG. 1d (top view) of a vertical take-off and landing vehicle containing a fuselage 17b and a set of four identical ducted fan units set to the front 42a, left 42b, right 42c, and rear 42d of the fuselage 17b. Each ducted fan unit is powered by its own power source (shown in FIG. 8, top view without fuselage), a front power source 50, a left power source 50, a rear power source 50, and a right power source 50.

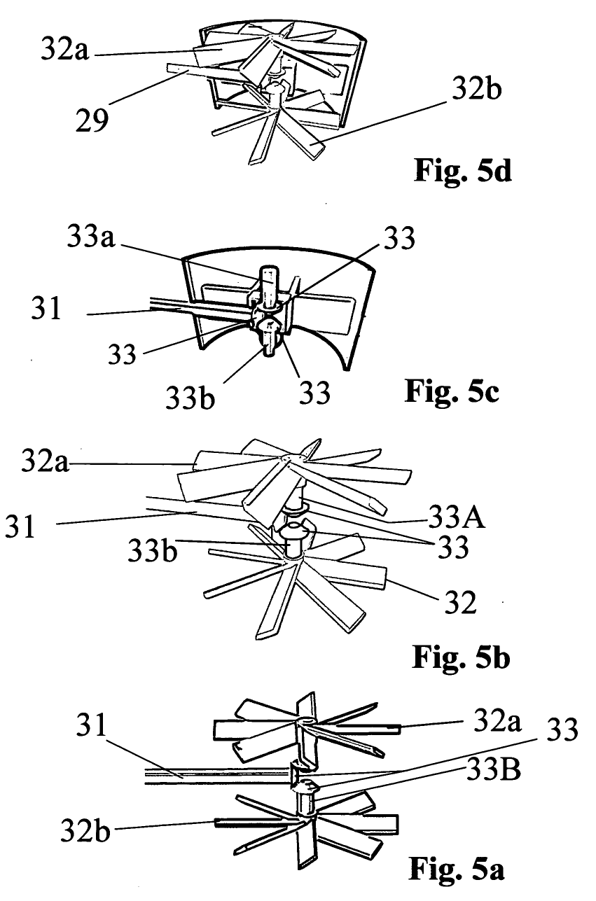

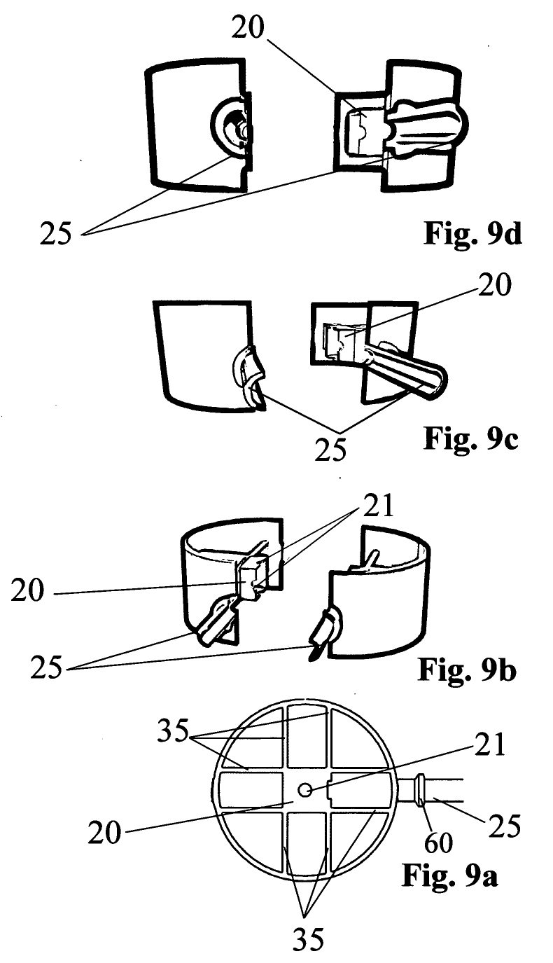

Each ducted fan unit is comprised of a set two counter rotating propellers (illustrated in FIGS. 5a and 5b); each propeller creates lift, a clockwise rotating propeller 32a and a counter-clockwise rotating propeller 32b. The two counter rotating propellers cancel out the torque effect normally encountered by having only one propeller. The propellers have a shaft (FIGS. 5b and 5c) attached to them that corresponds to their perspective rotation, a clockwise rotating propeller shaft 33a and a counter-clockwise rotating propeller shaft 33b. Each propeller unit 32a and 32b has a beveled gear 33 at the end of their shafts. Each ducted fan unit has a drive shaft 31 (FIG. 8) with both a drive shaft gear 51 attached, on the fuselage side of the shaft, and a beveled gear 33 (seen in FIG. 5c) attached to the opposite end, inside the ducted fan gear box. Each ducted fan units perspective power source 50 (seen in FIG. 8) transfers power to the drive shaft gear 51 attached to drive shaft 31. The drive shaft 31 (FIG. 5b and 5c) transfers power to the propeller shafts 33a and 33b through the interfacing of the beveled gears 33 at the end of each shaft. The drive shaft 31 interface with the propeller shafts 33a and 33b inside a ducted fan units gear box 20 (illustrated in FIG. 9a, 9b, 9c, and 9d). The propeller shafts 33a and 33b (FIG. 5b) transfers power to their perspective propellers 32a and 32b.

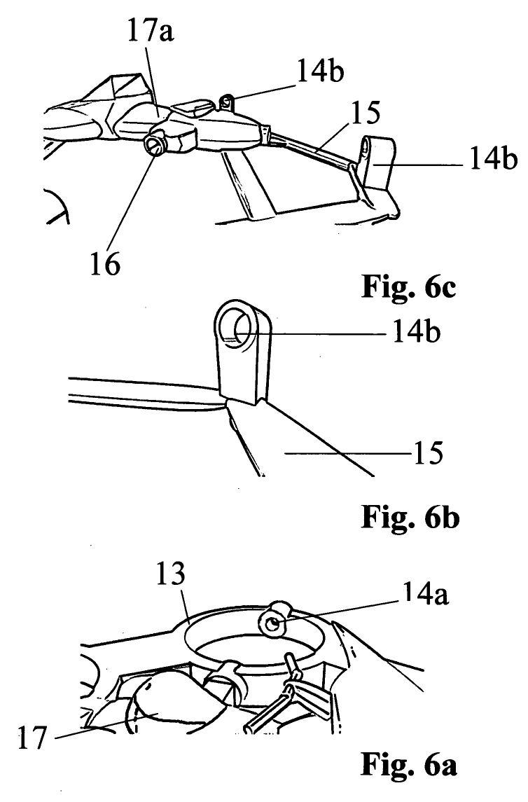

Each ducted fan unit has a hollow pivot shaft 25 (illustrated in FIGS. 9a, 9b, 9c, and 9d). The hollow pivot shaft 25 allows for the drive shaft 31 (FIGS. 5a, 5b, 5c, and 8) to pass anchors to the inside wall of the fuselage. The ducted fan unit itself acts as an anchor to the outside wall of the fuselage. The hollow pivot shaft fits through an opening (same as opening 16 illustrated on fuselage 17a in FIG. 6c) in the fuselage 17b. The ducted fan units have a gear box 20 (FIG. 9a) held in place by a series of support arms 35. The ducted fan gear box 20 (FIGS. 9a and 9b) has a set of openings 21 in the top, bottom, and the hollow pivot shaft 25 side of the gear box. The openings 21 allow for the drive shaft 31 (FIG. 5b) and propeller shafts 33a and 33b to enter the gear box 20 (FIG. 9a) and hold the gears 33 (FIG. 5b) in place. The ducted fan units have a hollow pivot shaft turning gear 24 (FIG. 8) attached to the hollow pivot shaft 25. The hollow pivot shaft turning gear 24 is used to interface with a servo and gear unit 26 (FIG. 8) to rotate the ducted fan unit.

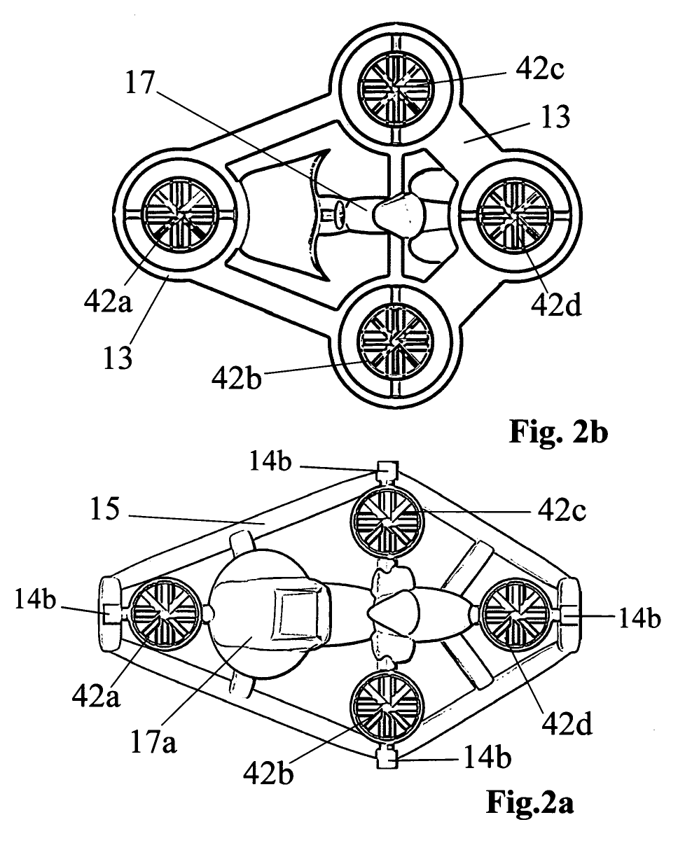

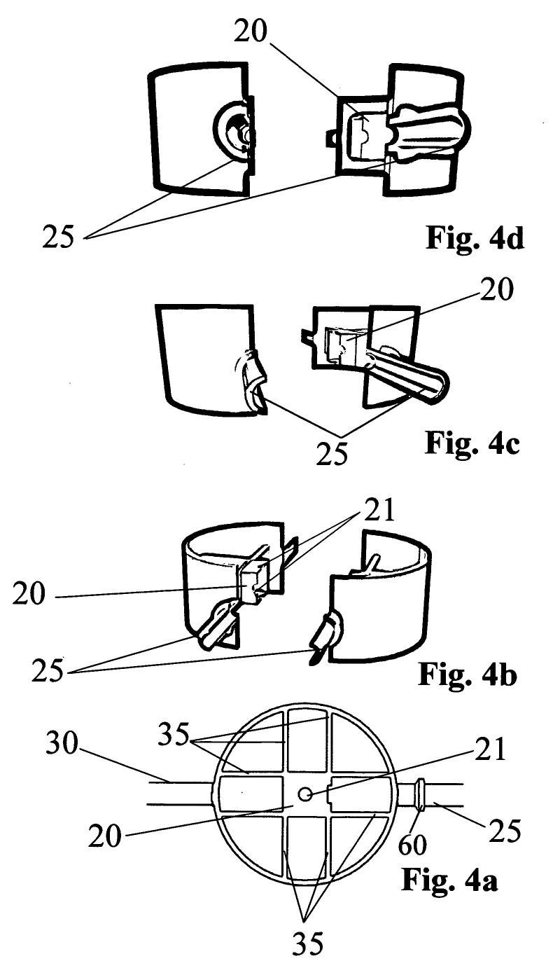

The second preferred embodiment is described in reference to FIGS. 1a, 2b, 4a, 4b, 4c, 4d, 5a, 5b, 5c, 5d, 6a, 6c, and 8 of the invention, a vertical take-off and landing vehicle. In the second preferred embodiment an outer frame 13 (FIG. 1a) is added to the invention for added support of the ducted fan units. Shown in FIGS. 1a and 2b of a vertical take-off and landing vehicle containing a fuselage 17 and a set of four identical ducted fan units set to the front 42a, left 42b, right 42c, and rear 42d of the fuselage 17. The fuselage has an outer frame 13 attached to it that helps hold the ducted fan units in place. The outer frame 13 has a series of pivot shaft mounting slots 14a (shown in FIG. 6a) positioned opposite every fuselage hollow shaft opening 16 (same opening as in FIG. 6c). The ducted fan units have a pivot shaft 30 (FIG. 4a) attached to the duct opposite the hollow pivot shaft 25 side of the duct. The pivot shaft 30 (FIG. 4a) mounts into the pivot shaft mounting slot 14a (FIG. 6a) and is held in place. The pivot shaft 30 (FIG. 4a) is a non-hollow pivot shaft. The outer frame 13 adds support to the ducted fan units.

The hollow pivot shaft 25 (FIGS. 4a and 4b) allows for the drive shaft 31 (FIG. 5b) to pass through. The hollow pivot shaft 25 (FIGS. 4a and 4b) has an enlarged ball bearing mounting 60 (FIG. 4a) that anchors to the inside wall of the fuselage. The ducted fan unit itself acts as an anchor to the outside wall of the fuselage. The hollow pivot shaft fits through an opening 16 (same as opening 16 illustrated on fuselage 17a in FIG. 6c) in the fuselage 17. The ducted fan units have a gear box 20 (FIG. 4a) held in place by a series of support arms 35. The ducted fan gear box 20 has a set of openings 21 in the top, bottom, and the hollow pivot shaft 25 side of the gear box. The openings 21 allow for the drive shaft 31 (FIG. 5b) and propeller shafts 33a and 33b to enter the gear box 20 and holds the gears 33 in place. The ducted fan units have a hollow pivot shaft turning gear 24 (FIG. 8) attached to the hollow pivot shaft 25. The hollow pivot shaft turning gear 24 is used to interface with a servo and gear unit 26 to rotate the ducted fan unit.

Each ducted fan unit is comprised of two counter rotating propellers; each propeller creates lift (illustrated in FIGS. 5a, 5b, and 5d), a clockwise rotating propeller 32a and a counter-clockwise rotating propeller 32b. The two counter rotating propellers cancel out the torque effect normally encountered by having only one propeller. The propellers have a shaft attached to them that corresponds to their perspective rotation, a clockwise rotating propeller shaft 33a (FIGS. 5b and 5c) and a counter-clockwise rotating propeller shaft 33b. Each propeller unit 32a and 32b has a beveled gear 33 at the end of their shafts. Each ducted fan unit has a drive shaft 31 (FIG. 8) with both a drive shaft gear 51 attached, on the fuselage side of the shaft, and a beveled gear 33 (FIG. 5a) attached to the opposite end, inside the ducted fan gear box. Each ducted fan units perspective power source 50 (FIG. 8) transfers power to the drive shaft gear 51 attached to the drive shaft 31. The drive shaft 31 (FIGS. 8 and 5c) transfers power to the propeller shafts 33a and 33b (FIG. 5c) through the interfacing of the beveled gears 33 (FIG. 5c) at the end of each shaft. The drive shaft 31 (FIG. 5c) interfaces with the propeller shafts 33a and 33b inside the ducted fan unit gear box 20 (FIGS. 4a, 4b, 4c, and 4d). The propeller shafts 33a and 33b (FIG. 5b) transfer power to their perspective propellers 32a and 32b.

### OPERATION—FIGS. 1D, 5B, 5C, 8—PREFERRED EMBODIMENTS

In operation of the ducted fan vertical take-off and landing vehicle the ducted fan units 42a, 42b, 42c and 42d (FIGS. 1d and 8) are set into their vertical position through the use of servo and gear units 26 (FIG. 8) and hollow pivot shaft gears 24. The power sources 50 spin the propellers 32a and 32b (FIGS. 5b and 5c) through the use of their perspective drive shafts 31 thus pulling the air into the ducted fan units 42a, 42b, 42c, and 42d (FIG. 1d) and then rapidly pushing it out the bottom creating lift.

To create forward movement the left and right ducted fan units 42b and 42c (FIG. 1d) are rotated forward, using the left and right servo units 26 (FIG. 8) and the left and right hollow pivot shaft turning gear 24, to a more horizontal position to move the air towards the back of the vehicle. To create backwards movement the left and right ducted fan units 42b and 42c (FIG. 8) are rotated backwards, using the left and right servo and gear units 26 and the left and right hollow pivot shaft turning gear 24, to move the air towards the front of the vehicle. To maneuver the vehicle, the front and rear ducted fan units 42a and 42d (FIG. 8) are rotated to the left and right to a more horizontal position, using the front and rear servo units 26 (FIG. 8) and the front and rear hollow pivot shaft turning gear 24, to turn the vehicle. Also, the front and rear ducted fan units 42a and 42d (FIG. 8) can be turned in conjunction with each other, both to the left or both to the right, using the front and rear servo and gear units 26 (FIG. 8) and the front and rear hollow pivot shaft turning gear 24, to create sideway movement of the vehicle by forcing the ducted fan units exhaust in said direction thus moving the vehicle into the direction desired.

To stop the vehicle in midair the left and right ducted fan units 42b and 42c (FIG. 8) are turned to face their exhaust in the reverse direction the vehicle is moving. For landing, all of the ducted fan units 42a, 42b, 42c, and 42d (FIG. 1d) are reposition in the vertical position and power to the ducted fan units is slowly decreased.

### DETAILED DESCRIPTION—FIGS. 1B, 1C, 2A, 3A, 3B, 3C, 4A, 4B, 4C, 4D, 5A, 5B, 5D, 6B, 6C, AND 7—ALTERNATIVE EMBODIMENT

FIGS. 1b, 1c, 2a, 3a, 3b, 3c, 4a, 4b, 4c, 4d, 5a, 5b, 5d, 6b, 6c, and 7 illustrate an alternative embodiment of my invention. In the alternative embodiment (as illustrated in FIGS. 1b, 1c, and 2a) of my invention the use of an outer frame 15 is maintained, much like in the second preferred embodiment, but shows a variation of the outer frame which is below the turning radius of a set of ducted fan units set to the front 42a, left 42b, right 42c, and rear 42d. This design allows for larger ducted fan units while still maintaining the same amount of space as the second preferred embodiment described above.

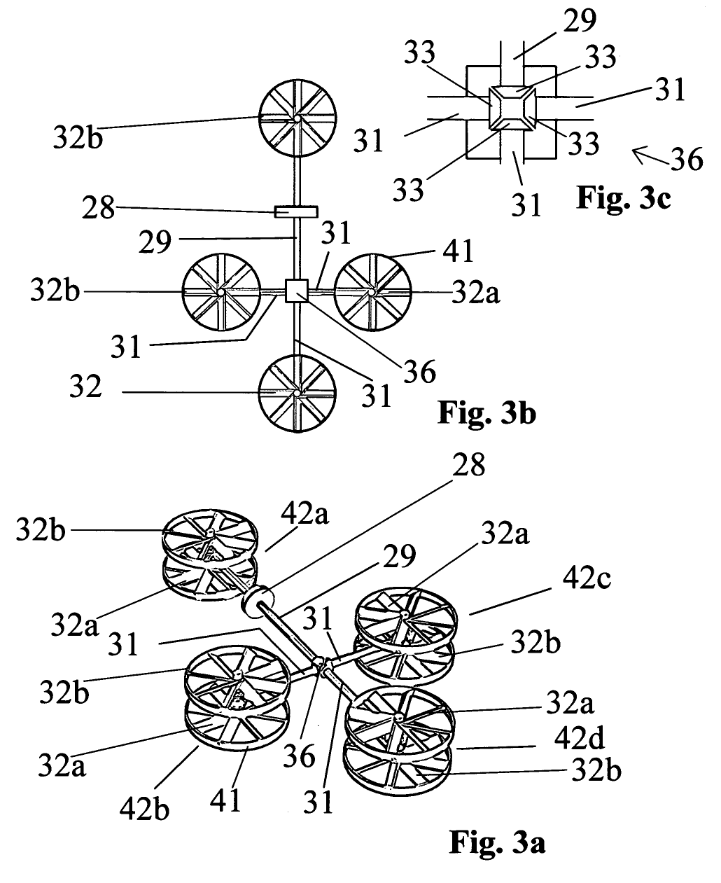

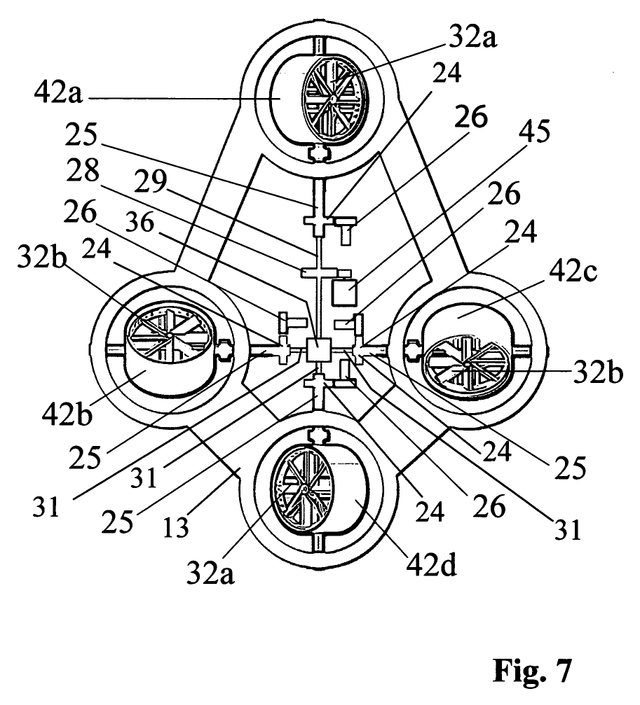

In the alternative embodiment of the invention a single power source 26 (shown in FIG. 7) layout is illustrate. Rotational power is transferred from a single power source 45 to a main drive shaft 29 through the use of a gear or transmission 28. The main drive shaft 29 transfers rotational power to a central gear box 36 (shown in FIGS. 3a, 3b, 3c, and 7). The central gear box 36 (FIG. 3c) has four openings in it to allow the front main drive shaft 29, a left drive shaft 31, a right drive shaft 31, and a rear drive shaft 31 to enter. Each drive shaft 29 and three 31's has a beveled gear 33 (FIG. 3c) on each end to transfer rotational power. The main drive shaft 29 transfers rotational power in the central gear box 36 to the three drive shafts 31 going to the left 42b, right 42c, and rear 42d ducted fan units. The main drive shaft 29 transfers power to a front ducted fan unit gear box 20 (gear box shown in FIGS. 4a, 4b, 4c, and 4d) using its front beveled gear.

Each ducted fan unit is comprised of two counter rotating propellers (illustrated in FIGS. 5a, 5b, and 5d); each propeller creates lift, a clockwise rotating propeller 32a and a counter-clockwise rotating propeller 32b. The two counter rotating propellers cancel out the torque effect normally encountered by having only one propeller. The propellers have a shaft attached (FIG. 5b) to them that corresponds to their perspective rotation, a clockwise rotating propeller shaft 33a and a counter-clockwise rotating propeller shaft 33b. Each propeller unit 32a and 32b has a beveled gear 33 (FIG. 5b) at the end of their shafts.

The layout of a single power source setup (FIG. 7) requires that the propellers 32a and 32b be positioned as such to create lift when the single power source 26 spins them. The front and left ducted fan units' top propellers should both be counter-clockwise rotating propeller 32b and the right and rear ducted fan units' top propellers should both be clockwise rotating propellers 32a. As in the preferred embodiments, the ducted fan units all have two counter rotating propellers (as seen in FIG. 5d) to cancel out the torque effect caused by its counter part.

The ducted fan units 42a, 42b, 42c, and 42d (FIG. 1c) have a pivot shaft 30 (FIG. 4a) opposite the hollow pivot shaft 25 side of the duct, same as in the second preferred embodiment described above. The ducted fan units pivot shaft 30 (FIG. 4a) mounts into a pivot shaft mounting 14b (shown in FIGS. 6b and 6c). A support ring 41 (FIGS. 3a and 3b) has been added to the propellers to reduce vibration noise from the propeller tips. The operation of the ducted fan units 42a, 42b, 42c, and 42d (FIG. 1c) is the same as described above in the first preferred embodiment of the invention.

### OPERATION—ALTERNATIVE EMBODIMENT—FIGS. 1C, 2A, 3A, 3B, 3C, 5A, 5B, 5C, 5D, AND 7

In operation of the alternative embodiment of the ducted fan vertical take-off and landing vehicle the ducted fan units 42a, 42b, 42c and 42d (FIGS. 1c, and 2a) are set into their vertical position through the use of servo and gear units 26 (FIG. 7) and hollow pivot shaft gears 24. The single main power source 45 (FIG. 7) transfers rotational power to the main drive shaft 29 via a gear/transmission 28. The main drive shaft 29 (FIG. 7) transfers rotational power to the front propeller units 32a and 32b (FIG. 5d) in the front ducted fan unit 42a (FIG. 7) and to the central gear box 36 (FIGS. 7, 3a, 3b, and 3c). Rotational power is transferred from the central gear box 36 to the left drive shaft 31, right drive shaft 31, and rear drive shaft 31. Each drive shaft 29 and three 31's transfers rotational power to their perspective ducted fan units propeller shafts 33a and 33b (FIGS. 5b and 5c) and thus to propellers 32a and 32b (shown in FIGS. 5a, 5b, and 5d). The spinning propellers 32a and 32b, as well as the acceleration of air from inlet to outlet, create lift from each of the ducted fan units 42a, 42b, 42c, and 42d (FIG. 2a).

To create forward movement the left and right ducted fan units 42b and 42c (FIG. 2a) are rotated forward, using the left and right servo units 26 (FIG. 7) and the left and right hollow pivot shaft turning gear 24, to a more horizontal position to move the air towards the back of the vehicle. To create backwards movement the left and right ducted fan units 42b and 42c (FIG. 2a) are rotated backwards, using the left and right servo units 26 (FIG. 7) and the left and right hollow pivot shaft turning gear 24, to move the air towards the front of the vehicle.

To maneuver the vehicle, the front and rear ducted fan units 42a and 42d (FIG. 2a) are rotated to the left and right to a more horizontal position, using the front and rear servo units 26 (FIG. 7) and the front and rear hollow pivot shaft turning gear 24 (FIG. 7), to turn the vehicle. Also, the front and rear ducted fan units 42a and 42d (FIG. 2a) can be turned in conjunction with each other, both to the left or both to the right, using the front and rear servo units 26 (FIG. 7) and the front and rear hollow pivot shaft turning gear 24 (FIG. 7), to create sideway movement of the vehicle by forcing the ducted fan units exhaust in said direction thus moving the vehicle into the direction desired.

To stop the vehicle in midair the left and right ducted fan units 42b and 42c (FIG. 2a) are turned to face their exhaust in the reverse direction the vehicle is moving. For landing, all of the ducted fan units 42a, 42b, 42c, and 42d (FIGS. 1c and 2a) are reposition in the vertical position and power to the ducted fan units is slowly decreased.

### CONCLUSION, RAMIFICATIONS, AND SCOPE

Accordingly, the reader will see that the vertical take-off and landing vehicle of this invention will provide a safe and practical way for public travel. The vertical take-off and landing vehicle can be created in a miniature, remotely controlled configuration and outfitted with a camera or other security devices to traverse through dangerous terrain or for entertainment purposes.

The scope of the invention should be determined by the appended claims and their legal equivalents, rather than by the examples given.

1. A vertical take-off and landing vehicle comprising:
(a) a fuselage forming a passenger compartment or mount and having a four sides, including a front side, a rear side and two lateral sides, said fuselage defining a central longitudinal axis of said vehicle;
(b) four thruster units capable of providing both vertical lift and horizontal thrust to said vertical take-off and landing vehicle, said thrusters being located around said fuselage as such, a front thruster unit located in front of said fuselage, a left thruster unit located to the left of said fuselage, a right thruster unit located to the right of said fuselage, and a rear thruster unit located to the rear of said fuselage. Said thruster units being movable between a first position in which they provide vertical lift and a second position in which they provide horizontal thrust.

2. The vertical take-off and landing vehicle according to claim 1, wherein said fuselage contains at least one power source.

3. The vertical take-off and landing vehicle according to claim 1, wherein each of said four thruster units are enclosed inside a duct as such to create four individual ducted thruster units, a front ducted thruster unit, a rear ducted thruster unit, a left ducted thruster unit, and a right ducted thruster unit.

4. The vertical take-off and landing vehicle according to claim 3, wherein each of the four ducted thruster units are comprised of two counter-rotating propellers, and a means of transmitting power from said power source to said propellers.

5. The vertical take-off and landing vehicle according to claim 3, wherein said ducted thruster units are connected to said fuselage by means of a hollow pivot shaft located as such: the front ducted thruster unit hollow pivot shaft is located to the rear of the ducted thruster unit in relation to said fuselage, the rear ducted thruster unit hollow pivot shaft is located to the front of the ducted thruster unit in relation to the fuselage, the left ducted thruster unit hollow pivot shaft is located to the right of the ducted thruster unit in relation to the fuselage, and the right ducted thruster unit hollow pivot shaft is located to the left of the ducted thruster unit in relation to the fuselage.

6. A vertical take-off and landing vehicle according to claim 3, wherein a means of maintaining position of said ducted thruster units around said fuselage is achieved.

7. The vertical take-off and landing vehicle according to claim 3, wherein said ducted thruster units are rotatable as such: said front ducted thruster unit is rotatable on its axis perpendicular to said fuselage, said rear ducted thruster unit is rotatable on its axis perpendicular to said fuselage, said right ducted thruster unit is rotatable on its axis parallel to said fuselage, and said left ducted thruster unit is rotatable on its axis parallel to said fuselage.

8. The vertical take-off and landing vehicle according to claim 7, wherein a means of providing rotation of said ducted thruster units is provided.

9. The vertical take-off and landing vehicle according to claim 1, wherein said fuselage contains a passenger compartment or a passenger mount for at least one person.
